(19) United States
(12) Patent Application Publication
(10) Pub. No.: US 2009/0240720 A1
(43) Pub. Date: Sep. 24, 2009

(54) Method and system for dynamically controlling functionality of an application program and storage medium for storing instructions which effectuate the method

(75) Inventors: Thomas C. Zavela, Farmington Hills, MI (US); Charles E. Pickett, Livonia, MI (US); Kenneth L. Cauvin, Livonia, MI (US)

Correspondence Address: BROOKS KUSHMAN P.C., 1000 TOWN CENTER, TWENTY-SECOND FLOOR, SOUTHFIELD, MI, 48075, US

(73) Assignee: Compuware Corporation, Detroit, MI (US)

(21) Appl. No.: 12/077,502

(22) Filed: Mar. 19, 2008

(51) Int. Cl. G06F 9/30; G06F 17/30

(52) U.S. Cl. 707/101; 712/226; 712/E09.016; 707/E17.009

(57) ABSTRACT

A method and system for dynamically controlling functionality of an application program and storage medium for storing instructions which effectuate the method are provided The method includes providing a data structure containing modifiable data which indicates current functionality of the application program. The method also includes providing a set of common instructions and first and second sets of optional instructions. The application program has a first functionality when the application program includes the set of common instructions and the first set of optional instructions. The application program has a second functionality different from the first functionality when the application program includes the set of common instructions and the second set of optional instructions. The method further includes modifying the modifiable data if a desired functionality for the application program is different from the current functionality of the application program. The method still further includes causing the application program to include either the first or second set of optional instructions based on the modifiable data to obtain the desired functionality.

### BACKGROUND OF THE INVENTION

1. Field of the Invention

This invention relates to methods and systems for dynamically controlling functionality of an application program and storage media for storing instructions which effectuate the methods.

2. Background Art

Often times, a user or customer at a customer site wants a component of a software product (i.e., application program) to work different than the generic product release.

Previous solutions were to provide the customer the unique code after implementation of the product at the customer site. However, once the unique code was implemented, it was not easy to revert back to the original code.

One possible solution was to modify the code in object format and have the customer apply the customized code in that format. However, once it was applied, it was not an easy task to revert to the original code base.

Other possible solutions include coding AMASPZAP (IBM superzap) to zap part of the generic distributed code for an individual site to apply to change the code functionality. However, this AMASPZAP code had to be fitted into each subsequent release of the product. Also, both of the above solutions would have to be distributed in media form to each user site that desired to use the unique code.

Another possible solution was using SMP/E (IBM) or similar to distribute an object or load module replacement to modify the code. This required a significant software development effort to create the software modification, develop a mechanism to activate the fix, and make it ready for distribution and implementation. Furthermore, it required significant effort on the user's end to implement the fix.

The previous methods described generally apply to the entire user site, to apply the modification or not.

### SUMMARY OF THE INVENTION

An object of at least one embodiment of the present invention is to provide an improved method and system for dynamically controlling the functionality of an application program and storage medium for storing instructions which effectuate the method.

In carrying out the above object and other objects of the present invention, a method of dynamically controlling functionality of an application program is provided. The method includes providing a data structure containing modifiable data which indicates current functionality of the application program. The method also includes providing a set of common instructions and first and second sets of optional instructions. The application program has a first functionality when the application program includes the set of common instructions and the first set of optional instructions. The application program has a second functionality different from the first functionality when the application program includes the set of common instructions and the second set of optional instructions. The method further includes modifying the modifiable data if a desired functionality for the application program is different from the current functionality of the application program The method still further includes causing the application program to include either the first or second set of optional instructions based on the modifiable data to obtain the desired functionality.

The data structure may include a data table.

The application program may operate as a software package having the first functionality when the application program includes the first set of optional instructions. The application program may operate as custom software having the second functionality when the application program includes the second set of optional instructions.

The first set of optional instructions may be a set of default instructions.

The method may further include the steps of receiving a signal and modifying the modifiable data in response to the signal to obtain modified data wherein the modified data indicates the desired functionality of the application program.

The modifiable data may include one or more flags.

Each flag may be a single byte flag.

The method may further include the step of determining whether the one or more flags are activated.

Further in carrying out the above object and other objects of the present invention, a system for dynamically controlling functionality of an application program is provided. The system includes means for providing a data structure containing modifiable data which indicates current functionality of the application program. The system also includes means for providing a set of common instructions and first and second sets of optional instructions. The application program has a first functionality when the application program includes the set of common instructions and the first set of optional instructions. The application program has a second functionality different from the first functionality when the application program includes the set of common instructions and the second set of optional instructions. The system further includes means for modifying the modifiable data if a desired functionality for the application program is different from the current functionality of the -application program. The system still further includes means for causing the application program to include either the first or second set of optional instructions based on the modifiable data to obtain the desired functionality.

The system may further include means for receiving a signal and means for modifying the modifiable data in response to the signal to obtain modified data wherein the modified data indicates the desired functionality of the application program.

The system may further include means for determining whether the one or more flags are activated.

A computer readable storage medium for storing a set of software instructions which, when executed, dynamically control functionality of an application program is provided. The set includes instructions for providing a data structure containing modifiable data which indicates current functionality of the application program. The set also includes instructions for providing a set of common instructions and first and second sets of optional instructions. The application program has a first functionality when the application program includes the set of common instructions and the first set of optional instructions. The application program has a second functionality different from the first functionality when the application program includes the set of common instructions and the second set of optional instructions. The set further includes instructions for modifying the modifiable data if a desired functionality for the application program is different from the current functionality of the application program. The set still further includes instructions for causing the application program to include either the first or second set of optional instructions based on the modifiable data to obtain the desired functionality.

The set of software instructions may further include instructions for receiving a signal and instructions for modifying the modifiable data in response to the signal to obtain modified data wherein the modified data indicates the desired functionality of the application program.

The set of software instructions may further include instructions for determining whether the one or more flags are activated.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a diagrammatic illustration of a computer at a user or customer site and including a microprocessor and a memory containing a table library, a data table, an application program and generic and unique code for the program; and

FIG. 2 is a block diagram flow chart illustrating one embodiment of a method of the present invention.

### DETAILED DESCRIPTION OF THE PREFERRED EMBODIMENT(S)

In at least one embodiment of a method of the invention, a data structure such as a data table allows a customer site to make at least one or more one-byte changes to the table which will change the execution of product instructions or code of an application program and allow a customer site to tailor the product to the site's or individual's needs with minimal input.

At least one embodiment of the method of the invention also simplifies the way that a software developer programmer needs to code a check to see if the site wants to execute the unique code. The unique code remains in the product from one release to the next and it prevents duplication of effort on the part of the software developer. It also minimizes the effort on the user's end since the user does not need to implement the unique code, but rather only needs to make one or more one-byte changes to the table.

In at least one embodiment of the method of the invention, all sites have access to the unique code via the table that is distributed as part of the product. A user is allowed to activate a fix by making a copy of the table and making a one-byte change to enable the unique code modification. The instructions or mechanism to activate the fix is in the product and the unique code switch remains in the product.

In other words, the at least one embodiment provides each customer with a table that contains default values and each customer can change the default values to customize the application software or program functionality. The table is dynamic by allowing the user to change the value of the data in the table at any time and it takes into account any future customization for any individual site using the product. The unique code is already in the shipped product and is accessible by all user sites.

The at least one embodiment has the ability to turn the unique code “on” or “off” by changing the one or more bytes of the table and the user or individual can use the modified code with the table change. The software engineer designer only needs to be concerned about the customized software code and does not have to be concerned with the architecture to have the customer site enable the customized software since the users already have a table that will activate the unique functionality by changing the table default value. The at least one embodiment of the invention saves time at the customer site since the users only have to change a one byte value to activate the unique functionality in the product.

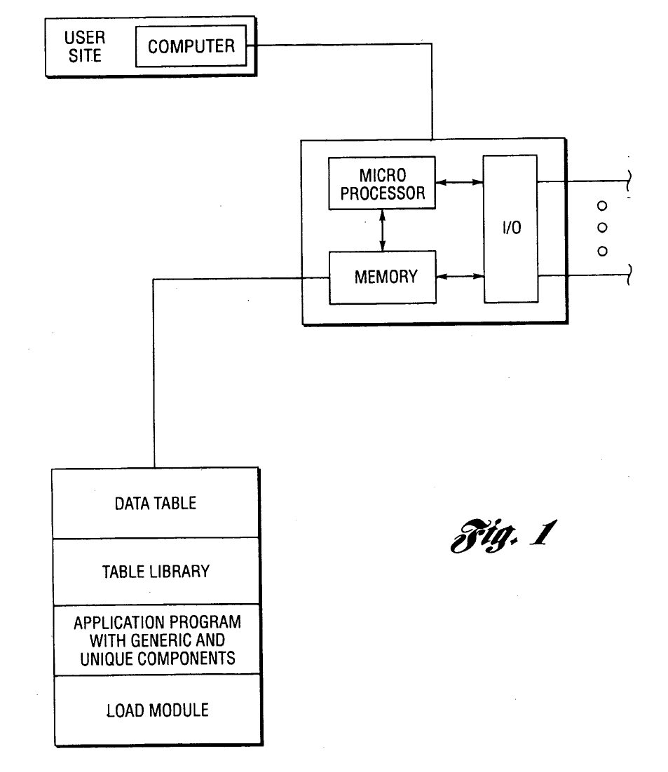

Referring now to FIG. 1, a user site includes a computer which, in turn, includes a microprocessor or CPU coupled to a memory and to input/output circuitry for communication with input and output devices (not shown). The memory is capable of storing a data table, a table library, an application program including common instructions and different sets of optional instructions and a load module as are further described herein.

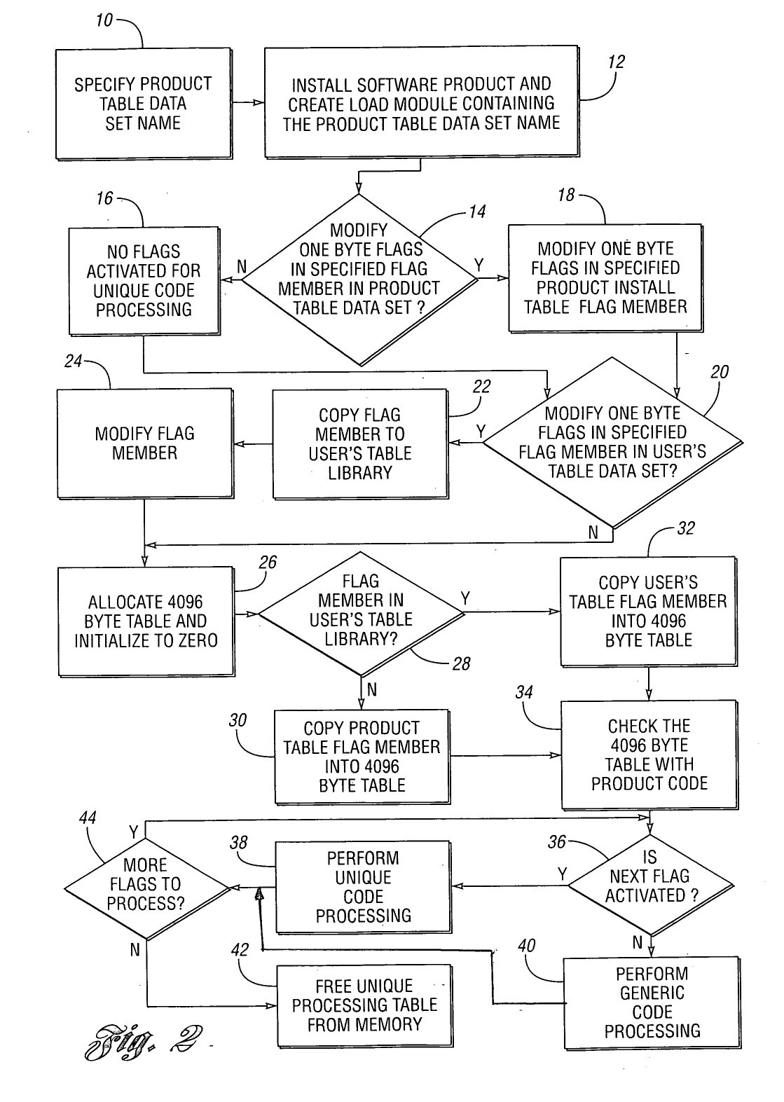

Referring now to FIG. 1 in combination with FIG. 2, there is illustrated the environment and process flow, respectively, of at least one embodiment of the present invention.

At block 10, a customer specifies a product table dataset name typically during software product installation at block 12. At block 12, a load module containing the product table dataset name is created.

At block 14, a customer can modify one-byte flags in the specified flag member in the product table dataset for each individual fix to activate unique code processing. If no modification is to be performed, at block 16, no flags are activated for unique code processing and block 20 is entered. If modification is to be performed, at block 18, modify one byte flags in the specified product install table flag member and block 20 is entered. At block 20, a one byte flag in the specified flag member in the user's table dataset can be modified for each individual flag to be activated.

If modification is desired, at block 22, the flag member may be copied to the individual user's table library and modified (i.e., block 24), in order to tailor unique code processing for one individual user. Then block 26 is entered.

If a modification is not desired, at block 26, the product entry code allocates an internal 4096 byte table and initializes it to zero.

At block 28, if the user has the flag member in her table library, then the flag member is copied into the internal 4096 byte table at block 32.

At block 30, if the user does not have the flag member in her table library, then the product table flag member is copied into the internal 4096 byte table.

At block 34, the product code checks one entry at a time in the internal 4096 byte table based on the assigned fix number, using direct accessing, to determine if a unique processing flag is activated for the customer at block 36.

At block 38, if the flag byte is activated, unique code processing is performed. Then block 44 is entered.

At block 40, if the flag byte is not activated, processing proceeds without performing any unique code processing (i.e., generic code processing is performed). Then block 44 is entered.

At block 44, it is determined whether there are more flags to process. Blocks 44 and 36 are repeated for each flag byte until all of the flag bytes have been checked.

At block 42, after all flags have been processed, the unique processing table is freed from memory so that a fresh copy is used during each execution of the product.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of dynamically controlling functionality of an application program, the method comprising:
providing a data structure containing modifiable data which indicates current functionality of the application program;
providing a set of common instructions and first and second sets of optional instructions, the application program having a first functionality when the application program includes the set of common instructions and the first set of optional instructions and the application program having a second functionality different from the first functionality when the application program includes the set of common instructions and the second set of optional instructions;
modifying the modifiable data if a desired functionality for the application program is different from the current functionality of the application program; and
causing the application program to include either the first or second set of optional instructions based on the modifiable data to obtain the desired functionality.

2. The method as claimed in claim 1, wherein the data structure comprises a data table.

3. The method as claimed in claim 1, wherein the application program operates as a software package having the first functionality when the application program includes the first set of optional instructions and the application program operates as custom software having the second functionality when the application program includes the second set of optional instructions.

4. The method as claimed in claim 1, wherein the first set of optional instructions is a set of default instructions.

5. The method as claimed in claim 1 further comprising the steps of receiving a signal and modifying the modifiable data in response to the signal to obtain modified data wherein the modified data indicates the desired functionality of the application program.

6. The method as claimed in claim 1, wherein the modifiable data comprises one or more flags.

7. The method as claimed in claim 6, wherein each flag is a single byte flag.

8. The method as claimed in claim 6 further comprising the step of determining whether the one or more flags are activated.

9. A system for dynamically controlling functionality of an application program, the system comprising:
means for providing a data structure containing modifiable data which indicates current functionality of the application program;
means for providing a set of common instructions and first and second sets of optional instructions, the application program having a first functionality when the application program includes the set of common instructions and the first set of optional instructions and the application program having a second functionality different from the first functionality when the application program includes the set of common instructions and the second set of optional instructions;
means for modifying the modifiable data if a desired functionality for the application program is different from the current functionality of the application program; and
means for causing the application program to include either the first or second set of optional instructions based on the modifiable data to obtain the desired functionality.

10. The system as claimed in claim 9, wherein the data structure comprises a data table.

11. The system as claimed in claim 9, wherein the application program operates as a software package having the first functionality when the application program includes the first set of optional instructions and the application program operates as custom software having the second functionality when the application program includes the second set of optional instructions.

12. The system as claimed in claim 9, wherein the first set of optional instructions is a set of default instructions.

13. The system as claimed in claim 9 further comprising means for receiving a signal and means for modifying the modifiable data in response to the signal to obtain modified data wherein the modified data indicates the desired functionality of the application program.

14. The system as claimed in claim 9, wherein the modifiable data comprises one or more flags.

15. The system as claimed in claim 14, wherein each flag is a single byte flag.

16. The system as claimed in claim 14 further comprising means for determining whether the one or more flags are activated.

17. A computer readable storage medium for storing a set of software instructions which, when executed, dynamically control functionality of an application program, the set comprising instructions for:
providing a data structure containing modifiable data which indicates current functionality of the application program;
providing a set of common instructions and first and second sets of optional instructions, the application program having a first functionality when the application program includes the set of common instructions and the first set of optional instructions and the application program having a second functionality different from the first functionality when the application program includes the set of common instructions and the second set of optional instructions;
modifying the modifiable data if a desired functionality for the application program is different from the current functionality of the application program; and
causing the application program to include either the first or second set of optional instructions based on the modifiable data to obtain the desired functionality.

18. The storage medium as claimed in claim 17, wherein the data structure comprises a data table.

19. The storage medium as claimed in claim 17, wherein the application program operates as a software package having the first functionality when the application program includes the first set of optional instructions and the application program operates as custom software having the second functionality when the application program includes the second set of optional instructions.

20. The storage medium as claimed in claim 17, wherein the first set of optional instructions is a set of default instructions.

21. The storage medium as claimed in claim 17 wherein the set of software instructions further comprises instructions for receiving a signal and instructions for modifying the modifiable data in response to the signal to obtain modified data wherein the modified data indicates the desired functionality of the application program.

22. The storage medium as claimed in claim 17, wherein the modifiable data comprises one or more flags.

23. The storage medium as claimed in claim 22, wherein each flag is a single byte flag.

24. The storage medium as claimed in claim 22 wherein the set of software instructions further comprises instructions for determining whether the one or more flags are activated.
